(19) United States
(12) Patent Application Publication
(10) Pub. No.: US 2010/0077428 A1
(43) Pub. Date: Mar. 25, 2010

(54) METHOD AND APPARATUS FOR PROVIDING SUPPLEMENTAL CONTENT WITH VIDEO MEDIA

(75) Inventors: NICOLE M. ARNOLD, CARY, NC (US); LYDIA M. DO, RALEIGH, NC (US); ZAMIR G. GONZALEZ, POUGHKEEPSIE, NY (US); JANE H. JENKINS, RALEIGH, NC (US); HEIDI L. LAGARES-VAZQUEZ, HIGHLAND, NY (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/235,885

(22) Filed: Sep. 23, 2008

(51) Int. Cl. H04N 7/10

(52) U.S. Cl. 725/34

(57) ABSTRACT

The present invention discloses a method and apparatus which processes video media with associated meta data, and filters the meta data according to viewer interests. Meta data which relates to viewer interests is presented to the viewer.

### BACKGROUND

The present invention relates to the field of television and video media, and more particularly to providing supplemental information with a television or video transmission to allow viewer the ability to obtain information about items depicted in the video media.

The majority of television programming, particularly terrestrial broadcast television, produces revenue with advertising. Typically advertisements, commonly referred to as commercials, are shown at intervals during a television program. Television networks tend to show commercials at the same times as other television networks. Viewers often avoid watching commercials, using the “commercial break” as an opportunity to peruse other channels, or do something else because the commercials tend to show products or services in which the viewer has little interest. Furthermore, digital video recording (DVR) devices are increasingly used to time shift television programs so that the viewer can watch them at another time, or on a delay. Some DVR devices allow viewers to effectively “pause” broadcast television signals, and then resume playing the signal by storing the signal and playing it from the pause point. Since the signal is stored, viewers can skip over commercials, defeating their purpose.

Other video media, such as “pay” channels and movies released on playable media, avoid using commercials as it distracts from the content, and viewers generally do not want to see commercials in media for which they are paying or have paid. Some efforts have been made to generate revenue in these forms of media, though, by using a means referred to as “product placement.” Product placement involves use of a recognizable product or product brand in a video program as part of the program, such as a prop, or item that characters in the program use or prominently display without making actual reference to the item. Product placement, while somewhat effective as an advertising means, relies on using easily recognizable and well known products or brands. If a viewer sees a more obscure item in a program, the viewer has no way to determine what it is, or where to obtain more information about the item.

Recently some media hosting websites have provided a means for users and others to provide tags for videos hosted by the site. A tag is a meta data structure that allows information to be associated with the video. The tags are associated with the video by time, and when the video is played, upon reaching a time where a tag has been provided, the information in the tag may be overlaid on the video so users can see the information. Keywords can be tagged to certain times of the video, corresponding to items seen in the video. These keywords may be displayed as anchors for hyperlinks which the viewer can click on to view a website associated with the keyword. Keyword linking allows media content providers to generate revenue by selling the rights to keywords. For example, the keyword “bicycle” can be used as a tag in videos showing a bicycle, and used to direct a viewer to a bicycle manufacturer's website, where the bicycle manufacturer has paid for the right to the keyword “bicycle.” However, this approach requires the viewer to select tags of interest and also sort through many that are not of interest. Furthermore, the arrangement of affiliating an advertiser with a keyword only provides the viewer with information provided by that particular advertiser, and not other related providers of services and goods. It also does not allow a viewer to acquire information about untagged items depicted in the video. Accordingly, there is a need for a means by which advertisers and other information providers can provide information to viewers.

### BRIEF DESCRIPTION OF THE SEVERAL VIEWS OF THE DRAWINGS

FIG. 1 is a block system diagram of a system providing video content with meta data, in accordance with an embodiment of the invention;

FIG. 2 is a block schematic diagram of a video information processing device, in accordance with an embodiment of the invention;

FIG. 3 illustrates a process of filtering meta data provided in correspondence with video media, in accordance with an embodiment of the invention;

FIG. 4 shows a user interest profile for use in filtering meta data provided in correspondence with video media, in accordance with an embodiment of the invention;

FIG. 5 shows a representation video media having associated tags for items depicted in the video media, in accordance with an embodiment of the invention;

FIG. 6 is a data structure diagram of a tag used in correspondence with video media, in accordance with an embodiment of the invention; and

FIG. 7 is a flow chart diagram of a method of providing supplemental information in video media, in accordance with an embodiment of the invention.

### DETAILED DESCRIPTION

The present invention discloses a solution for providing supplemental information with video media content. More specifically, the invention includes meta tags that are provided in correspondence with the video media content, and which pertain to items depicted in the video media content. The meta tags are processed according to viewer profiles to provide viewer interest results, providing the viewer with more information about items depicted in the video media content.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

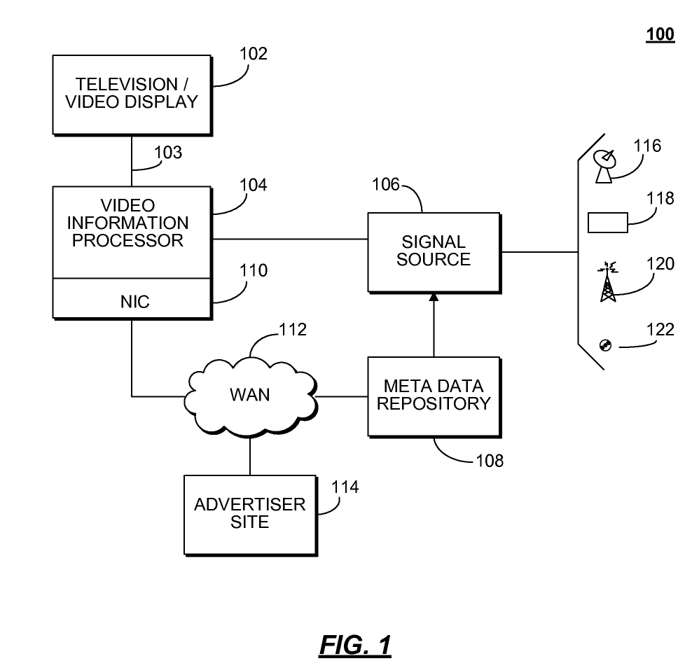

FIG. 1 is a block system diagram of a system 100 for providing video content with meta data, in accordance with an embodiment of the invention. The system 100 present video media on a video display 102. The video display may be a television set, computer display, or any equivalent video display apparatus. A video signal 103 is provided to the display by a video information processing device 104. The video information processing device receives a transmitted signal from a signal source 106. The transmitted signal includes a video signal and typically an associated audio signal corresponding to the video signal. The transmitted signal may be a television signal in analog form, a digitized video signal, and so on. Meta data corresponding to the video signal is provided with the video signal. In one embodiment, the meta data is provided from a meta data repository 108. The meta data repository stores meta data corresponding to the video signal. For example, if the video signal is a television program being broadcast by a television network, the meta data includes meta tags corresponding to items depicted in the television program. The meta data may be transmitted with the video signal on a sub-band or embedded in the video signal. In an alternative arrangement, the video information processing device 104 may be provided with a network interface card 110 allowing it to access a wide area data network 112, such as the Internet. The meta data repository may be connected to the network 112 and act as a server, allowing the video information processor 104 to download the corresponding meta data. The video information processor can determine the identity of the meta data to acquire based on, for example, the channel or source of the video signal and the time of day. Alternatively, the signal source may embed an identifier in the video signal or otherwise indicate an identifier that the video information processor may use to acquire the meta data. Thus, meta data may be provided over time, during transmission of the video signal, where, for example, meta tags may be transmitted in correspondence with depictions viewable in the video signal, or the meta data may be acquired at the commencement of the video signal, or a program or other such division.

As the video signal is displayed, the video information processor correlates the meta tags with items depicted in the video signal, as may be indicated by a time field of the meta tag, for example. Each meta tag may provide information about an item depicted in the video signal. Some meta tags may be “global” tags which relate generally to the program presently being displayed. The information in a meta tag may be, for example, a hyperlink to a manufacturer or advertisers web site 114 of the manufacturer or retailer offering the depicted item for sale, allowing a viewer interested in the item to obtain more information about the item and related materials. As will be discussed in more detail with regard to FIG. 4, the meta tags are processed according to a user interest profile, such that information in tags relevant to a given viewer's interest is provided to the viewer, while other tags may be suppressed or ignored.

The signal source 106 may be configured in a variety of forms. For example, the signal source may represent an original broadcaster, as well as re-transmitters between the original broadcaster and the video information processor. In one embodiment the signal source may be a satellite transmitter 116 which transmits signals by a satellite. Accordingly, the video information processor may include a satellite signal receiver which converts the received satellite signal to a playable video signal suitable for the display 102. The satellite signal may be digital or analog, and may include meta data in the signal, digitally embedded in the signal. Other types of signal sources include cable television providers 118, terrestrial television broadcasters 120, and video media 122 such as digital versatile discs (DVDs). Each of these sources may include meta data with the video signal, or may provide an indication as to how to acquire the corresponding meta data from an external source. Furthermore, the video information processor may include components necessary to receive video signals from any one of the signal sources, as well as additional types of signal sources. Additionally, it is contemplated that the video information device maybe provided with memory components to store a received video or television signal in digital form, allowing the viewer to replay the video signal and time shift viewing of the video signal. Meta data may be stored with the stored video signal.

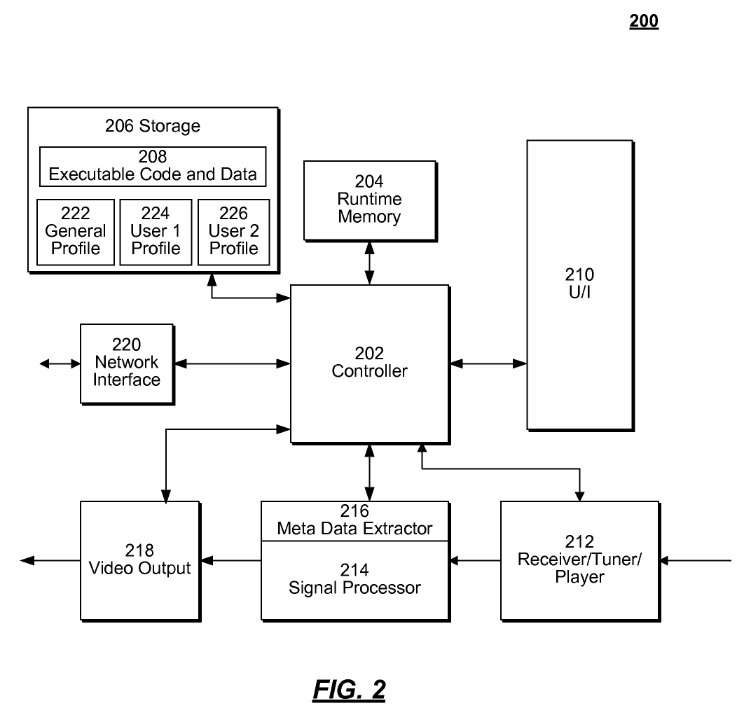

Referring now to FIG. 2, there is shown a block schematic diagram 200 of a video information processing device, in accordance with an embodiment of the invention. Central to the device is a controller 202 which is capable of executing machine code instructions designed in accordance with the teachings herein. Instruction code may be executed from a runtime memory 204, and may include operating system elements, user interface elements, and application elements. A storage memory component 206 may be used to store executable instruction code, as well as operating data 208. The instruction code may be instantiated in the runtime memory upon turning on power to the device, as is well known. The instruction code includes elements for operating a user interface 210, which may include various buttons, remote input receiver, as well as video output, option menus, and so on. The device 200 includes a means for receiving a video signal, such as, for example, a receiver or tuner 212. Other means for receiving, or generating the video signal, which may be used equivalently, include a DVD reader, a video tape reader, as well as reading digitized video from the storage memory 208. The means for receiving the video signal 212 is coupled to, and operated under control of the controller 202. The control can indicate a desired channel to tune to, or which portion of a recorded video media to play, for example. The received video signal may be processed by a signal processor 214 which may condition the video signal, perform filtering, band-shifting, audio extraction, and so on. If the received video signal contains meta data, then a meta data extractor 216 maybe used to acquire the meta data from the received signal. The extracted meta data is passed to the controller and may be stored in the storage memory 206 along with sufficient identifiers to relate the meta data to the video signal. The signal processor 214 and meta data extractor 216 may be a separate component from the controller, or they may be realized in software executed by the controller 202. The video signal is then passed to a video output function 218, which formats the video signal for the display apparatus. Different types of display require different types of formatting. For example, and analog television requires a standard analog television signal, while a computer display may require a digital signal or red, green, blue (RGB) signal. The video output is also coupled to the controller 202 to allow for control of the output. For example, the device may receive input from the user interface to adjust the contrast of the video signal.

In cases where the meta data is provided externally, meaning not along with the video signal source, a means to acquire the meta data is provided, such as a network interface 220. The network interface may allow the device to communicate with external devices, such as a meta data server or repository 108, as indicated in FIG. 1. The video signal may provide an identifier to allow acquisition of the meta data from the external source or the meta data may be acquired by correlating the time and channel over which the signal is received when the meta data is provided from an external source.

The invention correlates meta data with viewer preference by use of one or more profiles, such as a general profile 222, first user profile 224, and second user profile 226. Only one profile is needed, although it is contemplated that each different user of the video information processor may desire to create their own profile, and it is further contemplated that a general interest profile may be used. The profiles indicate the corresponding user or viewer's interests, as well as rules and settings. Meta data received in correspondence with video signal is filtered by comparing the meta data with the viewer's interests, as indicated by the viewer's profile. The meta data may be filtered as it is received, or, if available all at once, at one time, such as at completion of a program or playing of a video file. For each profile used, a different set of results will be produced. Thus, different viewers having different interests will receive customized results. The results may simply be displayed on the same video display, or other means may be used to deliver the results to the viewer such as, for example, emailing the results to the viewer's email account.

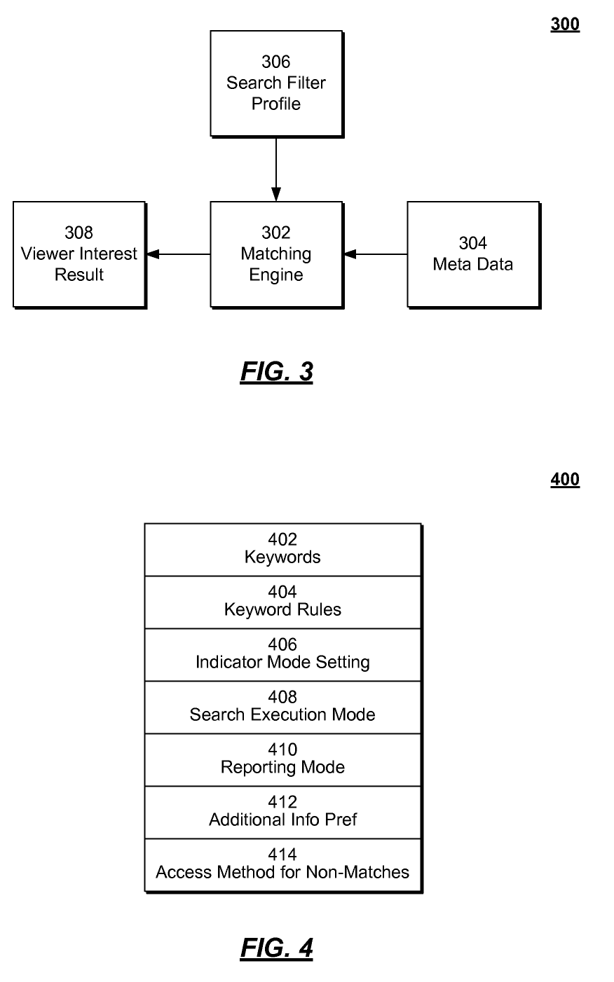

FIG. 3 illustrates a process 300 of filtering meta data provided in correspondence with video media, in accordance with an embodiment of the invention. A matching engine 302 is implemented in the video information processor, such as by computer instruction code. The matching engine takes meta data 304 and compares it with a search profile 306 to produce a viewer interest result 308. The profile 306 may be a general profile, a user or viewer-specific profile, or a compilation of profiles. Each profile indicates certain interests by, for example, the use of keywords provided by the viewer. Likewise, the meta data includes keywords relating to items depicted in the video program. The matching engine correlates the two, and matches of sufficient degree indicate a user may have interest in the item being depicted that is associated with the meta data. The meta data may be provided in tags, which include keywords and other information.

An example of a viewer interest profile arrangement is given in FIG. 4. FIG. 4 shows a user interest profile 400 for use in filtering meta data provided in correspondence with video media, in accordance with an embodiment of the invention. The profile is a data record which may be created by a viewer using a video information processor, facilitated by the user interface of the video information processor, and stored in a memory component of the video information processor. The profile may be identified by, for example, a name or other indicator so that results may be related to a particular viewer, or the profile may be a general profile. The exemplary profile 400 includes keywords 402. The keywords relate to interests of the viewer. For example, if the viewer is planning on getting married in the near future, the viewer may provide keywords such as “wedding,” “dress,” “catering,” and so on. A viewer interested in purchasing a new vehicle may, for example, provide keywords such as “car,” “sedan,” and “mileage.” The number of keywords allowed is limited only by memory space. Keywords may be provided as a simple list, or with Boolean operators such as “AND,” “OR,” and “NOT,” as is known. The application of keywords to the received meta data may be dictated by keyword rules 404. The keyword rules dictate, for example, the number of keywords that must be matched, whether exact matching is required, the number of times a given keyword must appear, and so on. The profile may further include an indicator setting which determines whether a visual or other perceptible indicator is enabled to indicate when an item depicted in the video program has associated meta data. For example, as tagged items appear in the video presentation, small graphic overlays may be displayed on the item to indicate to the viewer that there is information available regarding the item. The profile may include information regarding the viewers preferred search execution mode 408. For example the viewer may indicate a preference to have the meta data filtered over time, in correspondence with the video program, or the viewer may desire to have the meta data filtered at the conclusion of the program. Furthermore, the viewer may indicate whether all meta data associated with the program is to be filtered, or only meta data pertaining to selected items is to be filtered. The profile may also include a reporting mode preference 410, which indicates the manner in which the viewer wishes to receive the results of the filtering or comparison process. For example, the viewer may wish to have the results displayed on the video display at the conclusion of a program, or receive the results by other means, such as by email. The viewer may also indicate who to handle other meta information which did not match well with the viewers indicated preferences 412. That is, the viewer may still desire to see other meta information, even though it didn't match the viewer's indicated interest. In cases where the viewer's indicated interest doesn't produce any matches in the meta data associated with a program, the viewer may indicate a preferred method of handling non-matches 414. For example, if the user indicates an interest in rugs, using the keyword “rug,” but no match or related information is found in the meta data of a given program, the video information processor may seek out information using a network connection to query an internet search engine, and report some of the search engine results to the viewer. Likewise, during a program, the viewer may see an item of interest, select the item using a user interface provided by the video information processor, and provided keywords to define the item. The provided keyword may then be handled after filtering the meta data against the viewer's profile.

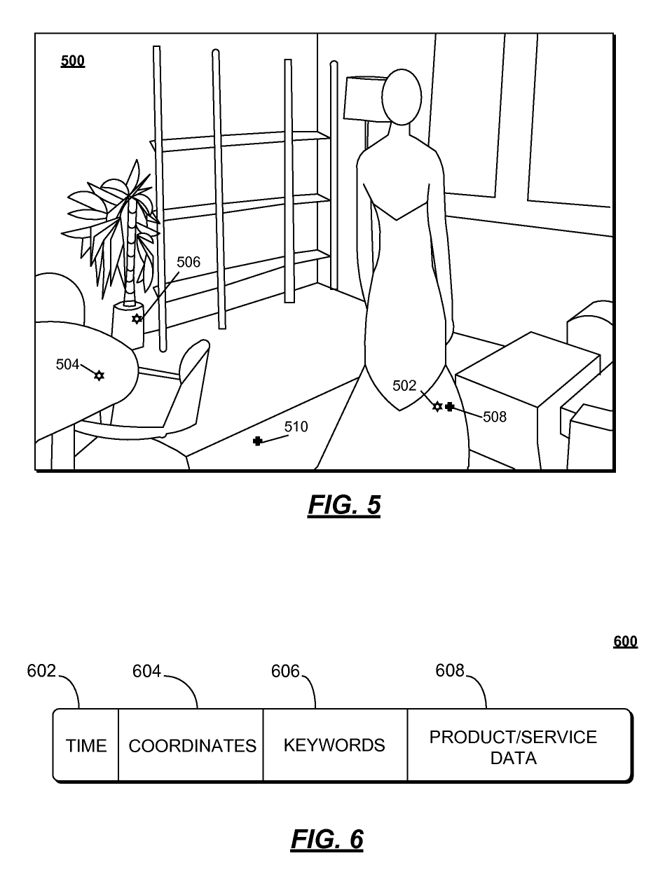

FIG. 5 shows a representation 500 of video media having associated tags for items depicted in the video media, in accordance with an embodiment of the invention. In particular, FIG. 5 represents a still frame of a video program or signal being played on a video display. The frame depicts a woman wearing a wedding dress, standing in a room, with her back to the viewer's perspective. In the present example, the viewer has indicated to have indicators displayed. Accordingly, sunburst icons 502, 504, and 506 appear on the dress, table, and plant, respectively. The icons may persist for a preselected period of time, and indicate that there is meta data corresponding to each of the depicted items. A cursor 508 may be directed by the user, via the user interface provided by the video information processor, to the icons to select the icon. Any item selected by the user may then have its associated meta data filtered by the viewer's profile. The cursor may be moved to other items, even though they do not have meta data associated with them. For example, the cursor is shown at position 510 over a rug. The lack of sunburst icon over the rug in the present example indicates there is no meta information relating to the rug, however, as indicated by field 414 of the exemplary profile shown in FIG. 4, the video information processor may acquire information that may relate to the rug, such as by prompting the viewer for keyword information, and then searching an external source, or determining if any of the meta information relating generally to the program or any items specifically match the viewer's indicated interest. It is contemplated that items depicted in the video may be marked by any perceptible means, including audible as well as visual marks, or a combination of various perceptible means of marking.

FIG. 6 is a data structure diagram 600 of a tag used in correspondence with video media, in accordance with an embodiment of the invention. The present tag is an exemplary data structure which may be included with meta data provided in correspondence with a video signal or program. A tag may relate to a particular item depicted in the video program, such as, for example, and one of the dress 502, table, 504, or plant 506 shown in FIG. 5. Alternatively, the tag may be a global tag which applies generally to the video program. A first data type that may be included in a tag is a time field 602, which indicates when the tag may be applicable during the video program. The time may be counted from the commencement of the program, or as the time of day, and may include date. Furthermore, the time field may indicate a time range during which an icon, graphic or other indicator may be made perceptible to the viewer. In conjunction with the time data, coordinate data 604 may be present to indicate where in the picture a graphic overlay is to be generated. The location indicated by the coordinate data correlates to the location of an item being depicted to which the tag corresponds. Accordingly, the video information processor may generate a graphic overlay, or other indicator at the coordinates, during the time indicated by the time data 602, if the viewer has enabled such feature, as indicated in the viewer's indicator mode setting 406, for example. The tag may further include keywords 606 which relate to item being depicted or to the program generally. The keywords may be generally related, such as “dress,” “table,” or “plant,” and may further include particular brand names, as well as keywords descriptive of related items, services, retailers, and so on. For example, for a tag corresponding to the dress 502 in FIG. 5, the keywords may include “dress,” “wedding,” “strapless,” “planner,” “catering,” “beaded,” “Vera Wang,” among others. A product/service data field 608 contains information about the item to which the tag corresponds. Information may be organized to correspond to keywords, as well as generally. For example, the keywords “wedding” and “dress” may be associated with the name of a local bridal shop, a wedding planning service, a wedding planning website, or the brand name of the dress actually shown in the video program, or any combination. The arrangement of information 608 and keywords is controlled by the provider of the video program or signal, who may include the names of retailers and service providers for a fee as a form of advertising. It is contemplated that the information in the product/service data 608 may be associated with keywords 606 based on order, such that, for example, the first keyword corresponds to the first item listed in 608. Furthermore, multiple items in the data section 608 may be related to a single keyword, and set apart form other items relating to other keywords by use of delimiters or punctuation. Thus, when the results of a filtering or matching process are provided to a user, all items in data field 608 corresponding to a matched keyword or words may be presented to the viewer.

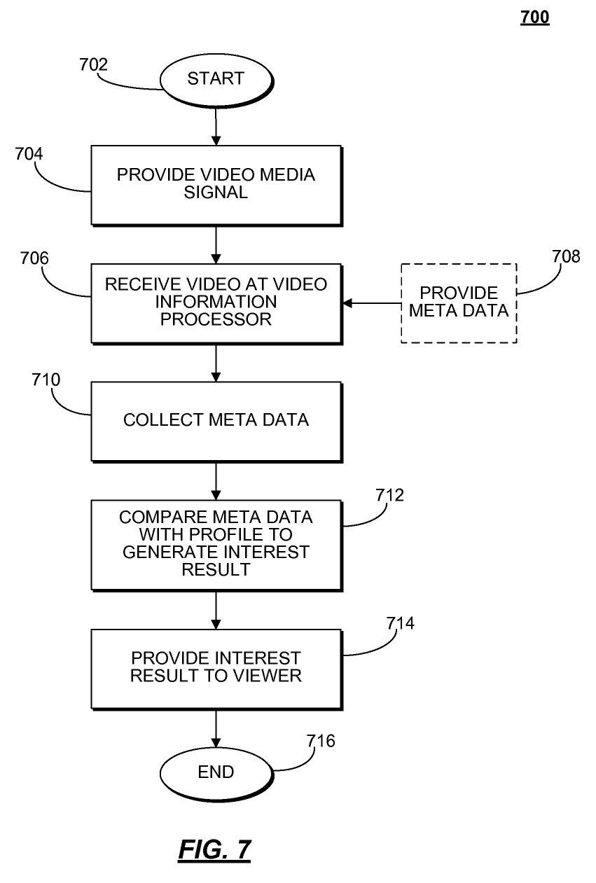

FIG. 7 is a flow chart diagram 700 of a method of providing supplemental information in video media, in accordance with an embodiment of the invention. At the start 702, the viewer has provided an interest profile, including keywords, and preference settings, if any. The profile may be stored in the video information processor. A video signal is then provided 704, which is received at the video information processor 706. The video may be provided by any of a number of sources, including broadcasters, cable networks, and video storage media. In some embodiments the meta data may be included with the video signal, in a sub-band, or embedded in the video signal, for example. In other embodiments it is contemplated that the meta data is provided separate from the video signal, and may be acquired externally 708. For example, the meta data may be downloaded from a web server, or acquired from the video media in cases where video media is the source of the video signal. As the video signal is played, the meta data is collected, in cases where the meta data is streamed with the video signal. The meta data may be stored in a storage memory component of the video information processor, or it may be accessed elsewhere by the video information processor in cases where the media data is provided in stored form. The meta data is compared with the profile or profiles maintained by the video information processor (712) to generate interest results. This filtering process of the meta data may be performed as meta data is received, at the conclusion of the video program, as well as in response to a viewer selecting items depicted in the video program. It is contemplated that all meta data corresponding to the video may be processed, or only meta data associated with selected items during playing of the video may be processed. Once the appropriate meta data is processed against the profile or profiles, the results are provided to the viewer 714. The results may be provided in response to a viewer selecting a marked item during the video, as the marked item appears. The results may also be shown by default at the end of a program containing tagged items. The results may be displayed on the video display, or may be made available by other means, such as by email. Subsequently the method terminates 716, although it may be repeated in part or in whole for other video programs.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing supplemental information content in a television transmission, comprising:
transmitting a television signal including depictions of items of potential viewer interest, the depictions occurring at event times;
providing, in correspondence with the television signal, a plurality of meta tags, each of the meta tags relating to one of the items depicted in the television signal and containing information about the depicted item;
filtering the meta tags according to a viewer interest profile to produce a viewer interest result, the viewer interest profile indicating subject matter of interest to a viewer, the filtering performed by a video information processing device which receives the television signal and plurality of meta tags and stores the viewer interest profile; and
presenting the viewer interest result upon a request from the viewer concerning an item depicted in the television signal, performed by the video information processing device.

2. A method for providing supplemental information as defined in claim 1, further comprising, wherein each of the meta tags includes information indicating a relative time at which its corresponding item is depicted, the method further comprises perceptibly marking the item based on the relative time to indicate the presence of a meta tag relating to the item, and wherein perceptibly marking the item includes at least one of an audible mark or a visual mark.

3. A method for providing supplemental information as defined in claim 2, wherein presenting the viewer interest result is performed in response to at least one of the viewer selecting the marked item or upon conclusion of program presently being viewed.

4. A method for providing supplemental information as defined in claim 1, wherein filtering the meta tags includes performing a keyword search to match keywords provided in the viewer interest profile with keywords provided in the meta tags.

5. A method for providing supplemental information as defined in claim 4, wherein the keyword search is performed upon conclusion of a television show presented by the television signal.

6. A method for providing supplemental information as defined by claim 1, wherein providing the meta tags is performed by transmitting the meta tags with the television signal.

7. A method for providing supplemental information as defined by claim 1, wherein providing the meta tags is performed by serving the meta tags to the video information processing device over a data network.

8. A method for providing supplemental information as defined in claim 1, further comprising storing the television signal and the meta tags at the video information processing device to allow time shifting of the television signal.

9. A method for providing advertising content in a video program, comprising;
receiving a video signal at a video information processing device, the video signal containing depictions of items of potential viewer interest;
receiving at the video information processing device, in correspondence with the video signal, meta tags corresponding to the items;
comparing the meta tags to a viewer interest profile to determine which of the meta tags contain data of interest to a viewer; and
presenting the data of interest to the viewer, performed by the video information processing device.

10. A method for providing advertising content as defined in claim 9, further comprising, wherein each of the meta tags includes information indicating a relative time at which its corresponding item is depicted, the method further comprises perceptibly marking the item based on the relative time to indicate the presence of a meta tag relating to the item, and wherein perceptibly marking the item includes at least one of an audible mark or a visual mark.

11. A method for providing advertising content as defined in claim 10, wherein presenting the data of interest is performed in response to at least one of the viewer selecting the marked item or upon conclusion of a program presently being viewed.

12. A method for providing advertising content as defined in claim 9, wherein comparing the meta tags includes performing a keyword search to match keywords provided in the viewer interest profile with keywords provided in the meta tags.

13. A method for providing advertising content as defined in claim 12, wherein the keyword search is performed upon conclusion of a television show presented by the video signal.

14. A method for providing advertising content as defined by claim 9, wherein providing the meta tags is performed by transmitting the meta tags with the video signal.

15. A method for providing advertising content as defined by claim 9, wherein providing the meta tags is performed by serving the meta tags to the video information processing device over a data network.

16. A method for providing advertising content as defined in claim 9, further comprising storing the video signal and the meta tags at the video information processing device to allow time shifting of the video signal.

17. An apparatus for providing supplemental information content in video media, comprising:
a processor;
a memory having a viewer interest profile stored therein and instruction code which, when executed by the processor configures the processor to:
receive a video signal containing depictions of items of potential viewer interest;
receive, in correspondence with the video signal, meta tags corresponding to the items;
compare the meta tags to a viewer interest profile to determine which of the meta tags contain data of interest to a viewer; and
present the data of interest to the viewer upon a request from the viewer.

18. An apparatus for providing supplemental information content as defined in claim 17, further comprising, wherein each of the meta tags includes information indicating a relative time at which its corresponding item is depicted the apparatus is further configured to perceptibly mark the item based on the relative time to indicate the presence of a meta tag relating to the item, and wherein perceptibly marking the item includes at least one of an audible mark or a visual mark.

19. An apparatus for providing supplemental information content as defined in claim 18, wherein the apparatus is configured to present the data of interest in response to the viewer selecting the marked item.

20. An apparatus for providing supplemental information content as defined in claim 17, wherein the apparatus is further configured to compare the meta tags by performing a keyword search to match keywords provided in the viewer interest profile with keywords provided in the meta tags.
